(19) United States
(12) Patent Application Publication
(10) Pub. No.: US 2013/0080218 A1
(43) Pub. Date: Mar. 28, 2013

(54) CUSTOMIZED CONTENT DELIVERY SYSTEM

(71) Applicant: REAPSO, LLC, Farmington Hills, MI (US)

(72) Inventors: William J. Wildern, IV, Farmington Hills, MI (US); Steven J. Valentine, Novi, MI (US)

(73) Assignee: REAPSO, LLC, Farmington Hills, MI (US)

(21) Appl. No.: 13/623,352

(22) Filed: Sep. 20, 2012

Related U.S. Application Data
(60) Provisional application No. 61/602,770, filed on Feb. 24, 2012.
(60) Provisional application No. 61/538,181, filed on Sep. 23, 2011.

(51) Int. Cl. G06F 21/00; G06Q 30/02; H04N 21/258

(52) U.S. Cl. 705/14.1; 725/30; 726/5; 726/4

(57) ABSTRACT

A method includes receiving an access code at one or more server computers from a user device that is associated with a user. In response to receiving the access code at the one or more server computers, the method includes accessing, at the one or more server computers, user preference information that is associated with the user of the user device, selecting a set of content items based at least in part on the access code, selecting at least one content item from the set of content items based at least in part on the user preference information, and transmitting information corresponding to the at least one content item from the one or more server computers to the user device.

### CROSS-REFERENCE TO RELATED APPLICATIONS

This application claims the benefit of U.S. Provisional Patent Application No. 61/602,770, which was filed on Feb. 24, 2012 and is incorporated by reference in its entirety. This application claims the benefit of U.S. Provisional Patent Application No. 61/538,181, which was filed on Sep. 23, 2011 and is incorporated by reference in its entirety.

### BACKGROUND

The recent proliferation of internet-connected computing devices has led to the creation of many new channels by which content is delivered to consumers. While many of these channels are sponsored by advertisements, consumers have become increasingly disengaged from advertising content as a result of constant exposure to advertising. As a result, many users ignore advertisements, or employ technological measures that prevent advertisements from being displayed in conjunction with the content that they are viewing. This has led to a decrease in the efficiency of online advertising.

Targeting advertisements based on user preferences has proven effective in some content delivery channels, such as web-based advertisements. However, effective advertisement targeting requires information regarding the user. This information is, in many cases, difficult to obtain. Efforts by some advertising platforms to track user behaviors for the purpose of targeting advertisements have compounded this problem by making users reluctant to share information regarding their tastes and preferences.

### SUMMARY

The disclosure relates to a customized content delivery system.

One aspect of the disclosed embodiments is a method that includes receiving an access code at one or more server computers from a user device that is associated with a user. In response to receiving the access code at the one or more server computers, the method includes accessing, at the one or more server computers, user preference information that is associated with the user of the user device, selecting a set of content items based at least in part on the access code, selecting at least one content item from the set of content items based at least in part on the user preference information, and transmitting information corresponding to the at least one content item from the one or more server computers to the user device.

Another aspect of the disclosed embodiments is a method that includes receiving an access code at one or more server computers from a user device that is associated with a user. In response to receiving the access code at the one or more server computers, the method includes accessing, at the one or more server computers, user preference information that is associated with the user of the user device, selecting at least one content item based at least in part on the user preference information and not based on the access code, and transmitting information corresponding to the at least one content item from the one or more server computers to the user device.

Another aspect of the disclosed embodiments is a method that includes causing an access code to be transmitted along with video content, wherein the access code is received at a user device that is associated with a user. The method also includes receiving the access code and a time value from the user device at one or more server computers, wherein the time value corresponds to a time at which the access code was received at the user device. In response to receiving the access code at the one or more server computers, the method includes validating the access code based at least in part on the time value, wherein the access code is valid if the time value occurs within a predetermined time period after transmission of the video content, selecting at least one content item, and transmitting information corresponding to the at least one content item from the one or more server computers to the user device.

### BRIEF DESCRIPTION OF THE DRAWINGS

The description herein makes reference to the accompanying drawings wherein like reference numerals refer to like parts throughout the several views, and wherein:

FIG. 1 is an illustration showing an example of an implementation of a system for delivering content to users.

FIG. 2 is an illustration showing an example of a preference interface.

FIG. 3 is an illustration showing an example of a ranking interface.

FIG. 4A-4D is an illustration showing examples in which a user device receives an access code from an external object.

FIG. 5 is an illustration showing a game interface.

FIG. 6 is an illustration showing an award interface.

FIG. 7 is an illustration showing a reward redemption interface.

FIG. 8 is an illustration showing a partner interface.

FIG. 9 is a flowchart showing an example of a process for delivering content items

FIG. 10 is a block diagram of an example of a hardware configuration for the user device.

### DETAILED DESCRIPTION

The systems and methods described herein allow for delivery of content to users. These systems and methods can provide customized digital content to a consumer/user via a user device (e.g., mobile phone, tablet, personal computer, etc.). The problems associated with conventional marketing are overcome because content such as collectables and rewards are chosen based on a user's preferences in a manner that is non-invasive to the user's privacy. Collectable items may be in the form of images, jokes, fortunes, audio clips, video clips, etc. Reward items may be coupons (e.g., dollar or percentage discount) or another type incentive to utilize the goods and/or services of a content partner (e.g., free shipping offer).

Access to content can be conditioned upon transmission of an access code from a user device to a content delivery system. The content items to which access is granted can be selected at least in part on the basis of user preference information, to provide relevant content to users based on their individual preferences. Distribution of access codes can be managed by an operator of the content delivery system and can be sponsored by content partners, retail partners, other partners, and the operator of the content delivery system to promote brand engagement or to provide incentives to customers.

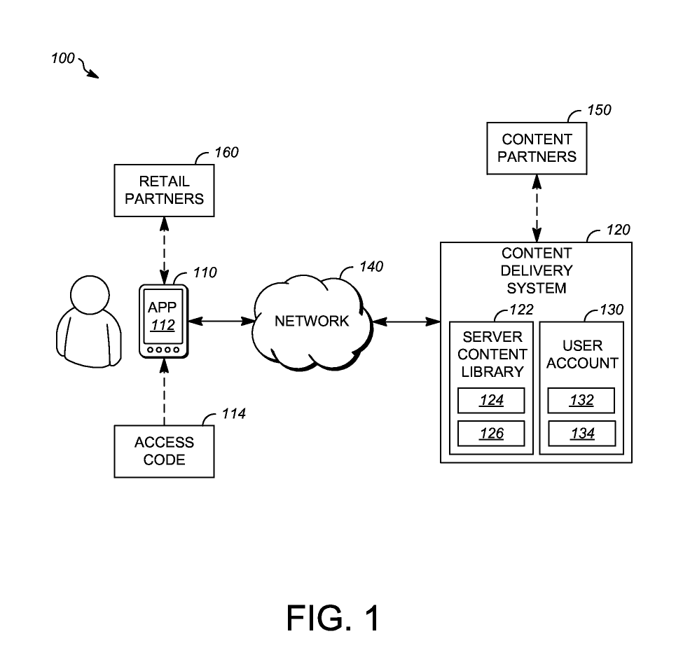

FIG. 1 is a block diagram of an example of an implementation of a system 100 for delivering content to users. A user device 110 is operable to communicate with a content delivery system 120. The content delivery system 120 can be implemented by, for example, one or more server computers. Communication between the user device 110 and the content delivery system 120, as well as other computer-based systems discussed herein, can occur via a network 140 that allows for the transmission of signals and/or data between devices that are connected to the network 140. One or more content partners 150 can be included in the system 100 and may, but need not be, in communication with and provide content to the content delivery system 120 via the network. One or more retail partners 160 can be included in the system 100 and may, but need not be, in communication with the content delivery system 120 via the network 140. In some instances, a partner may be both a content partner 150 and a retail partner 160.

The user device 110 can be a smart phone (computationally-enabled mobile telephone), tablet computer, laptop computer, desktop computer or other mobile computing device that can connect to the server computers of the content delivery system 120 via the network 140. The user device 110 can store and execute a client application 112. The client application 112 can be a software program that is stored in a storage medium that is associated with the user device 110 and includes computer program instructions that, when executed by the user device 110, cause the user device 110 to perform operations that will be described further herein.

The user device 110 can be operable to receive one or more access codes 114. Access codes 114 can each be a machine readable code in the form of signals or data in any form that can be perceived and interpreted by the user device 110. In some implementations, access codes 114 are received from a remote location, such as by transmission of signals or data via the network 140. For example, access codes 114 can be information, such as an alphanumeric string or an image (e.g., bar code, two-dimensional bar code, graphic art, photo, or logo) that can be transmitted by any suitable means for transmitting information, such as via a web page or email. In other implementations, access codes 114 are each associated with an object that is located in the same general location as the user device 110, as will be explained further herein. Access code 114 can be distributed to and obtained by the user through various channels. As examples, a user could purchase access codes 114, receive access codes 114 as a reward for the purchase of an item, receive access codes 114 as part of a promotion, receive access codes 114 from another user using the content delivery system 120 or receive access codes 114 from the operator of the content delivery system 120, or receive access codes 114 at a business or event. Access codes 114 can also be used to distribute content items regarding a person, business or other subject matter provided by the content partner 150. Access codes 114 can be associated with other users. Scanning another user's access code 114 can, in some implementations, add the other user to a “friends list.” In some embodiments, scanning an access code 114 can provide a non-user (i.e., a person who is not registered with content delivery system 120) access to the client application 112 so that the non-user can become a user.

A user may also be assigned a person access code 114 that provides information regarding a user's person personal preferences. One user's personal access code 114 may also be accessed by another user to determine the degree to which the personal preferences of the two users are compatible.

The content delivery system 120 can be implemented by one or more server computers. The one or more server computers of the content delivery system 120 can be provided with software in the form of computer program instructions that, when executed by the one or more server computers, cause the one or more server computers to perform operations that will be described further herein.

The content delivery system 120 can include a server content library 122. The server content library 122 can be used to store content items such as collectable items 124 and reward items 126 provided by, for example, the content partners 150 or the operator of the content delivery system 120. The collectable items 124 can include, but are not limited to, digital images, video, music, text and/or other information. The reward items 126 can include, but are not limited to coupons or tokens that are issued by the content partners 150, and which can be redeemed for discounts, coupons, goods and/or services. The reward items 126 can also include to access codes 114.

The content delivery system 120 can store information that defines a user account 130 for each user of the content delivery system. Information identifying a user, such as a user name, email address, login and password can be associated with each user account 130. Each user account 130 can include information regarding the user, such as user preference information 134 that describes the preferences of the user. Each user account can also include a user content library 132. The user preference information 134 can include information regarding the user that is associated with the user account 130, as will be described further herein. The user content library 132 allows content items to be associated with the user account 130. For example, the user content library 132 can be defined by information identifying the content items from the server content library 122 that the user that is associated with the user account 130 is permitted to access. In some implementations, the user can view representations of the items in the user content library 132 in the form of a user interface of the client application 112. Items in the user content library 132 may, but need not be, transferred to and stored at a storage medium that is associated with the user device 110.

In some embodiments, the only identifying information stored in each user account 130 for a user can be non-personal identifying information. For example, a user may sign up for the system with only an email address with associated password and may provide a user name, gender, and postal code, if necessary without providing personal information such as name, phone number, address, etc. Thus, one benefit of the content delivery system 120 is that users may sign up and use the content delivery system 120 without specifying or providing any personal identifying information.

Access to items in the server content library 122 can be granted to the user account 130 in response to transmission of the access code 114 from the user device 110 to the content delivery system 120. The access code 114 can be transmitted from the user device 110 to the content delivery system 120 at the time that the access code 114 is received by the user device 110. In other implementations, the access code 114 may also be saved by the user device 110 and transmitted to the content delivery system 120 at a later time.

When the access code 114 is scanned or otherwise received at the user device 110, the access code 114 and certain information identifying the user account 130 associated with the user device 110 are transmitted to the content delivery system 120. In response to receiving the access code 114 from the user device 110, the content delivery system 120 validates the access code 114, if the access code 114 is valid, grants the user access to one or more content items from the server content library 122 by updating the user content library 132 that is associated with the user account 130 that is associated with the user device 110.

When an access code (e.g., access code 114) is scanned or otherwise received at the user device 110 by a non-user, the access code can be transmitted to the content delivery system 120. In response to receiving an access code 114 from a user device 110 by the non-user, the non-user can be directed to download the client application 112 so that the non-user can become a user.

The content delivery system can validate the access code 114 (i.e. determine whether the user is authorized to use the access code) based on one or more validation criteria. The validation criteria can include, for example, whether the user has previously submitted the same access code 114 to the content delivery system 120, whether the user has previously submitted the same access code 114 to the content delivery system 120 within a predetermined time period, or whether a different user has previously submitted the same access code 114 to the content delivery system 120. By applying validation criteria, the access codes 114 can be configured to be utilized in multiple ways, such as access codes 114 that allow one usage only, access codes 114 that allow one usage per user, and access codes 114 that can be used multiple times by the same user subject to the expiration of a lock-out period.

In one implementation, access to one of the content items is only granted upon transmission of certain access codes 114 to the content delivery system 120. Access to the content items can be granted on a one-to-one basis with respect to transmission of a certain access code 114 from the user device 110 to the content delivery system 120.

Access to content items can be traded among users. For example, the content delivery system 120 can implement an exchange system in which users can trade their respective rights to access content items. For example, the user can trade its right to access a first content item for the right to access a second content item, and as a result of the trade, the user no longer possesses the right to access the first content item upon receiving access to the second content item. The second item may be one that was forfeited by another user or may be a content item that was provided by a content partner 150 directly to the exchange system. The user may also be able to trade the first content item for one or more access codes 114 rather than a new content item. The user may also be able to trade one or more access codes 114 for a content item. The user may also gift one or more access codes 114, or its right to access a content item to another user and receive nothing in return.

The network 140 can include multiple networks of varying types, including LANs, WANs, and the internet in any combination. Wired and/or wireless communications protocols can be used.

The content partners 150 can include third parties that are not associated with the user of the user device 110 or the operator of the content delivery system 120. At least some of the collectable items 124 and the reward items 126 that are included in the server content library 122 of the content delivery system 120 are provided by the content partners 150. In some implementations, which will be explained herein, the content partners 150 must satisfy one or more conditions in order to be permitted to add content items to the server content library 122. In one example, the content partners 150 are businesses that pay a fee to the operator of the content delivery system 120 for the right to add collectible content 124 and reward content 126 items to the server content library 122. In another example, content partners 150 are businesses that pay a fee to the operator of the content delivery system 120 for each reward content 126 item that is acquired by a user and each reward content 126 item that is activated by a user. In another example, content partners 150 are users, businesses or individuals who own content items and submit those content items to the operator of the content delivery system 120 for approval to add the items to the server content library 122. In some implementations, a voting mechanism is implemented by the content delivery system 120, which allows users to vote as to whether or not new content items are added to the server content library 122. In such a system, new content items can be added to the server content library 122 in response to receiving at least a threshold number of votes from users of the content delivery system 120.

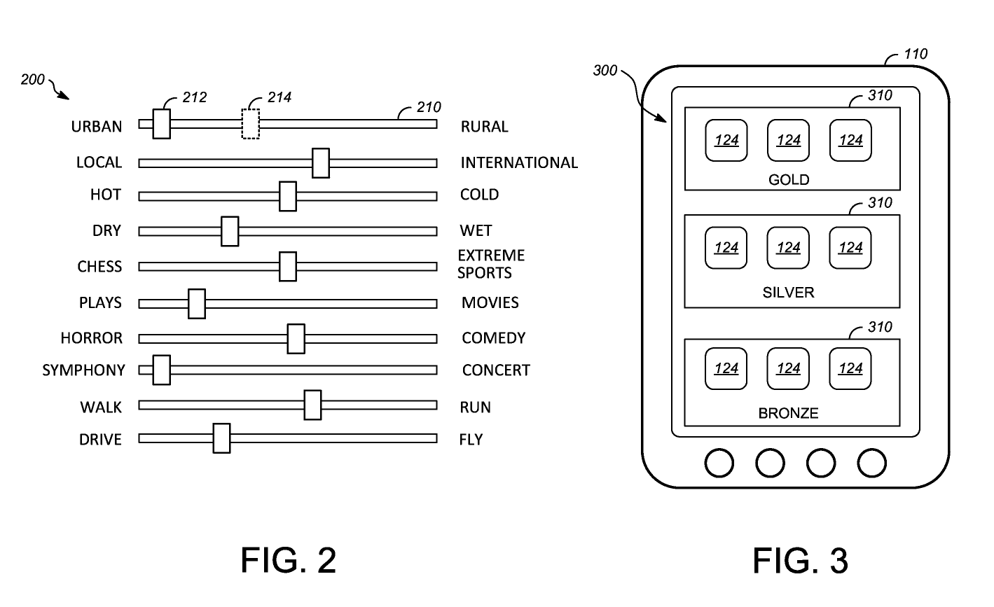

FIG. 2 shows an example of a preference interface 200 that can be used by a user to provide a portion of the user preference information 134 and cause it to be stored at the content delivery system 120 as part of the user account 130. The preference interface 200 can be used in implementations where the user explicitly provides a portion of the user preference information 134 to the content delivery system 120.

In one example, the client application 112 can cause the preference interface 200 to be displayed at a display screen of the user device 110. The preference interface 200 can include a plurality of controls 210, such as slider bar controls having movable elements 212, which can be used by the user to describe the user's preferences regarding each of a plurality of word pairs. In some implementations, an indicator 214 can be displayed in association with each of the controls 210, where the indicator 214 represents an assessment by the content delivery system 120 as to the preferences of the user based on the content items that are included in the user content library 132, and optionally based on user feedback such as ratings or rankings that are applied to the content items in the user content library 132. Although a single set of word pairs are shown in the preference interface 200, multiple interfaces can be used, each with different sets of words pairs which can, in some implementations, each correspond to a specific type of content item. In addition, other interfaces or types of descriptors can be used to express the user preference information 134.

In some implementations, some or all of the content items in the server content library 122 can be described using item characteristics that correspond to certain information in the user preference information 134. For example, the preference interface 200 could be used by the content partners 150 to describe content items or the types of users that are believed to be interested in those content items. This item characteristic information can be used by the content delivery system 120 to select content items for users, thus allowing users to receive content items that correspond to their individual preferences 134.

Further, rather than describe the individual content items, the content partner 150 itself can be generally described using characteristics that correspond to certain information in the user preference information 134. For example, the preference interface 200 can be used by the content partners 150 to describe the types of users that are believed to be generally interested in their content items. Similar to as described previously, this content partner information can be used by the content delivery system 120 to select customized content items for users.

FIG. 3 shows an example of a ranking interface 300 that can be utilized to explicitly discern a portion of the user preference information 134. In one example, the client application 112 can cause the rank interface 300 to be displayed at the display screen of the user device 110. The user can rank some of the content items, such as collectable items 124, by placing them into tiers 310 (e.g. “GOLD,” “SILVER,” and “BRONZE”) according to the user's affinity for those content items. In another embodiment, rather than placing the collectable items 124 into tiers, they may be ranked into numerical lists or may be otherwise ranked according to any other suitable technique. The user preferences can be inferred based on these rankings solely or in combination with information regarding the collectible items 124. The information regarding the collectible items 124 can be, for example, similar to characteristic information as discussed previously in connection with FIG. 2. In other examples, the rank interface 300 can be used to rank the reward items 126, can be used to rank the collectible items 124 and the reward items 126 concurrently, can be used to rank the content partners 150, or can be used to rank other types of content items. User rankings of collectable items 124, reward items 126, and content partners 150 can be maintained as part of the user preference information 134.

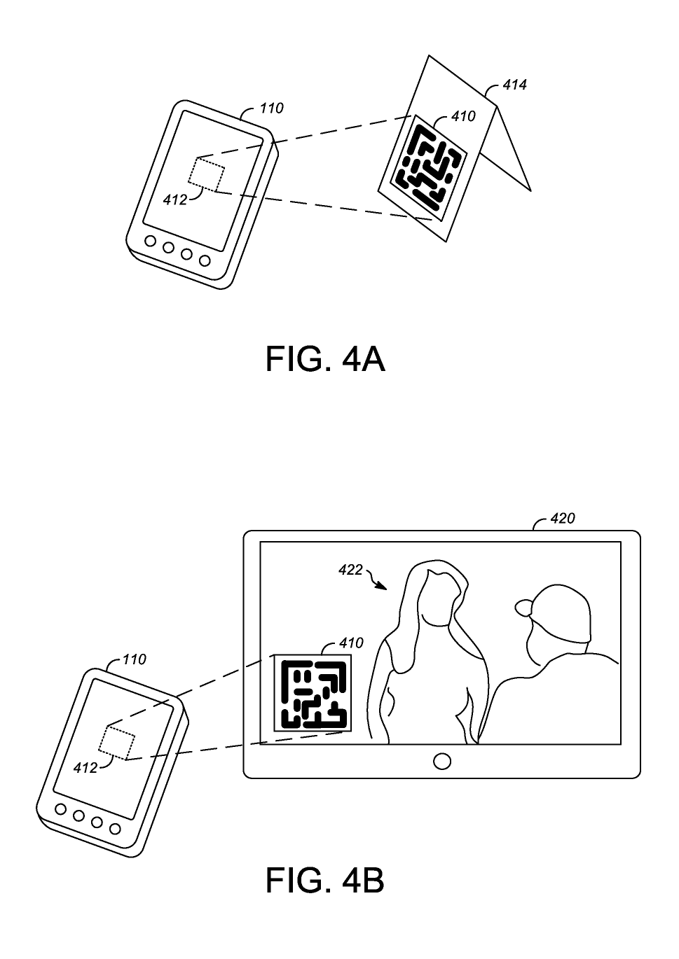

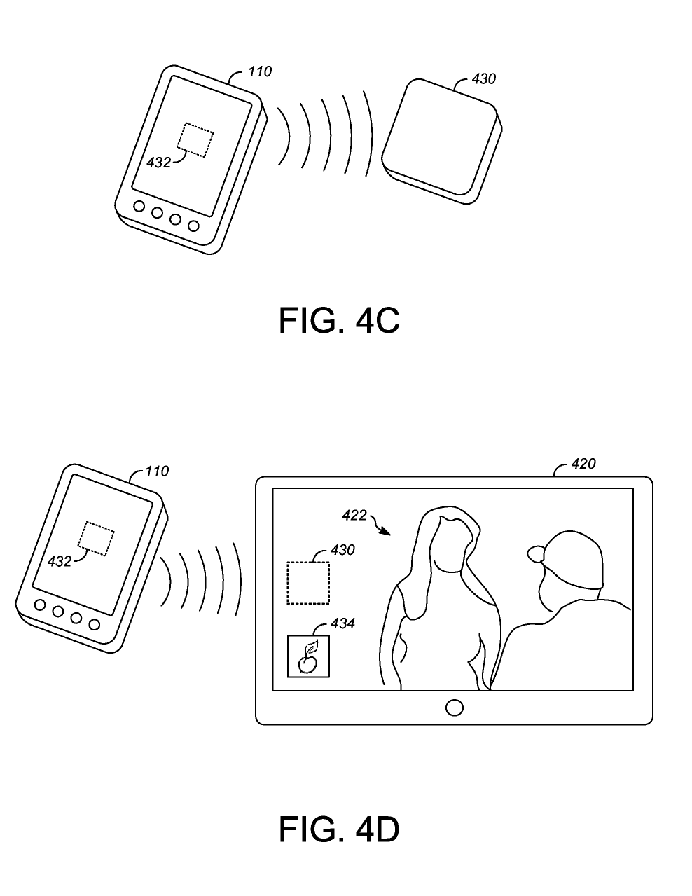

FIGS. 4A-4D are illustrations showing examples in which the user device 110 receives the access code 114 via an external object that is located in the same general location as the user device 110. The external object can be any device or structure capable of displaying, transmitting, or otherwise making the machine readable code available to the user device 110. These devices and structures are sometimes referred to herein as tags.

In FIGS. 4A-4B, the access code 114 is encoded in a symbolic tag 410 that can be scanned by an optical sensor 412 that is associated with the user device 110. The symbolic tag 410 can be in a form that can be visually perceived by the user. As one example, the symbolic tag 410 can be in the form of a barcode in any now known or later developed format, including linear barcodes, such as UPC barcodes, and matrix barcodes, such as QR codes. In another example, the access code 114 can be in the form of a digital image, company logo, or other graphic design. In implementations where the symbolic tag is a barcode, the optical sensor 412 can be a barcode reader, a camera, or other device that is able to scan barcodes. In implementations where the symbolic tag is an image, such as a logo, the optical sensor 412 can capture the image so that the client application 112 or the content delivery system 120 can retrieve an access code associated with the image.

In some implementations, the symbolic tag 410 can be printed or otherwise displayed on any manner of static display 414 (FIG. 4A), examples of which include but are not limited to signs, posters, flyers, magazines, printed advertisements, menus, table tents, confetti, newspapers, billboards, and business cards. In addition, when the access code 114 that is encoded in the symbolic tag 410 on the static display 414 is transmitted to the content delivery system 120, validation of the access code 114 can include applying validation criteria by transmitting geolocation information from the user device 110 to the content delivery system 120 and determining whether the symbolic tag 410 was scanned by the user device 110 at a location that corresponds to the location of the static display 414, wherein the access code 114 is validated if scanned at a location corresponding to the static display 414, and is not validated if it was scanned at a location that does not correspond to the static display 414, thereby preventing an unauthorized party from copying and redistributing the symbolic tag 410.

In some implementations, when the access code 114 that is encoded in the symbolic tag 410 on the static display 414 is transmitted to the content delivery system 120, a reward content item, if provided to the user, may be able to be redeemed immediately or may contain a redemption delay feature such that it cannot be redeemed for a certain period of time following the receipt of the access code 114 by the one or more server computers.

In other implementations, the symbolic tag 410 can be transmitted by presenting the symbolic tag 410 on a changeable display, such as a video image produced by a display screen 420, such as a television or a computer monitor. For example, the symbolic tag 410 can be superimposed on video content 422, such as an advertisement that is sponsored by one of the content partners 150. While the advertisement or other video content 422 is being displayed on the display screen 420, the symbolic tag 410 can be scanned by the optical sensor 412. In one example, such as a scheduled or live broadcast, when the access code 114 that is encoded in the symbolic tag 410 from the display screen 420 is transmitted to the content delivery system 120, validation of the access code 114 can include applying validation criteria by determining whether the symbolic tag 410 was scanned by the user device 110 during the time period in which the advertisement or other video content 422 was scheduled for display on the display screen 420, wherein the access code 114 is validated if scanned during the appropriate time period, and is not validated if it was not scanned during the appropriate time period, thereby preventing an unauthorized party from copying and redistributing the symbolic tag 410. To allow validation based on the time at which the access code 114 was received at the user device 110, the user device 110 can transmit a time value to the content delivery system 120 along with the access code 114. As long as the time value occurs within a predetermined time period (e.g., one minute) after transmission of the video content, the access code can be validated. In this example, the content partners 150 incentivize users to view the advertisement or other video content 422 during the time scheduled, and receive confirmation that the advertisement or other video content 422 has been viewed, via transmission of the access code 114 to the content delivery system 120 by the user.

In another implementation, such as a recorded broadcast, when the access code 114 that is encoded in the symbolic tag 410 from the display screen 420 is transmitted to the content delivery system 120, validation of the access code 114 can include applying validation criteria by determining whether the symbolic tag 410 was scanned by the user device 110 during an acceptable time period after the scheduled broadcast in which the advertisement or other video content 422 was scheduled for display on the display screen 420. In this implementation, the access code 114 can be validated if the time value occurs within a predetermined time value (e.g., one week) after transmission of the video content. Thus, the access code is validated if scanned during the predetermined time period after the scheduled broadcast, and is not validated if it was scanned after the predetermined time period, thereby preventing an unauthorized party from copying and redistributing the symbolic tag 410 after an acceptable time period. To allow validation based on the time at which the access code 114 was received at the user device 110, the user device 110 can transmit a time value to the content delivery system 120 along with the access code 114. In this example, the content partners 150 can incentivize users to view the advertisement or other video content 422 during the predetermined time period after the scheduled broadcast, and receive confirmation that the advertisement or other video content 422 has been viewed, via transmission of the access code 114 to the content delivery system 120 by the user.

In FIGS. 4C-4D, the access code 114 is encoded in the form of signals and/or data that are wirelessly transmitted from a wireless tag 430. The signals and/or data that are wirelessly transmitted from the wireless tag 430 can be received using a wireless signal receiver 432 that is associated with the user device 110.

The wireless tag 430 can be any device suitable to transmit the machine-readable code using any protocol or format now known or later developed, such as Radio-Frequency Identification (RFID), Near Field Communication (NFC) as defined by the ISO/IEC 18092 standard and the ECMA-340 standard, or wireless networking technologies such as the Bluetooth and 802.11 standards. The wireless signal receiver 432 of the user device 110 can receive the signals and/or data transmitted from the wireless tag using an antenna or an inductor in communication with wireless receiver circuitry of the appropriate type.

The wireless tag can 430, in some implementations, be incorporated into the same type of objects to which the symbolic tag 410 can be applied (FIG. 4C). For example, a wireless tag 430 in the form of a passive NFC tag could be attached to a sign, poster, table tent or other article. In other examples, the wireless tag could be transmitted to the user device 110 from an external electronic device, such as a smart phone or a television.

As another example, the wireless tag 430 can be associated with a display screen 420 (FIG. 4D), and can be operable to transmit the access code 114 to the wireless signal receiver 432 of the user device 110 during the time period in which the advertisement or other video content 422 is presented on the display screen 420. An icon 434 can be superimposed on the advertisement or other video content 422 to indicate to the user that the wireless tag 430 is ready to transmit and/or transmitting the access code 114 that corresponds to the advertisement or other video content 422.

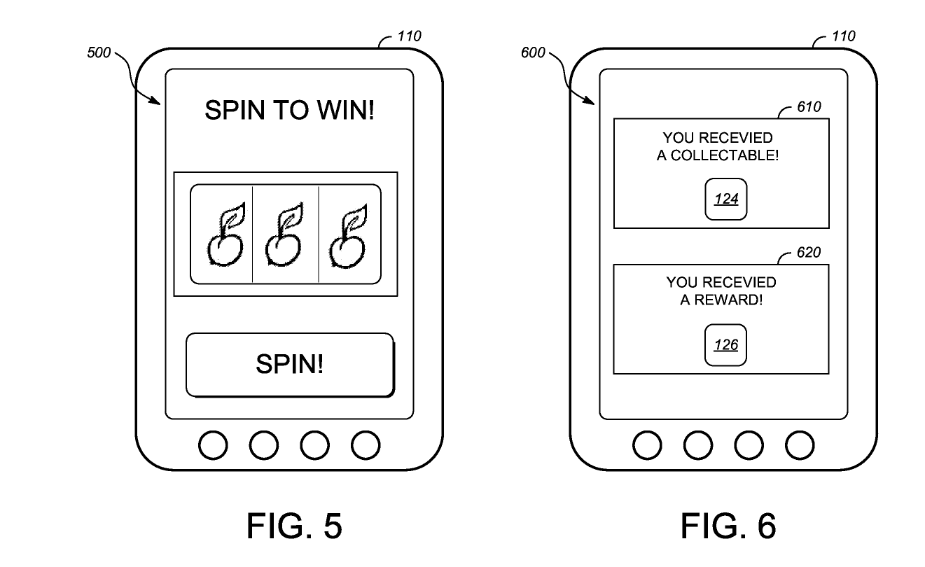

FIG. 5 is an illustration showing a game interface 500. The game interface 500 can be displayed at the user device 110 in response to receiving an access code 114 at the user device 110, such as by scanning or wireless transmission. The game interface 500 can be displayed while the access code 114 is being transmitted to the content delivery system 120 and is being validated at the content delivery system 120. In some implementations, an outcome of a game that is played by the user via the game interface 500 can be used by the content delivery system 120 to select content items that are awarded to the user. In some implementations, the content delivery system 120 can transmit a selection of two or more content items to the user for selection. The game interface 500 can be used to allow the user to choose one or more of these content items thereby allowing the user to select the content item(s) that are most desirable to the user.

After the access code 114 is validated at the content delivery system 120, one or more content items, such as the collectable items 124 and the reward items 126, are awarded to the user. In some implementations, one of the collectable items 124 and one of the reward items 126 are awarded to the user upon each transmission of a valid access code 114 to the content delivery system 120 from the user device 110.

FIG. 6 is an illustration showing an award interface 600 that identifies content items that have been awarded to the user by the content delivery system 120. The content delivery system 120 can transmit information to the user device 110 that causes the user device 110 to define the award interface 600. The award interface 600 can include, for example, a collectable item award message 610 and/or a reward item award message 620.

In some implementations, the content items that are awarded to the user are selected by the content delivery system 120 without regard to the access code 114 itself. In such implementations, the manner in which the access code 114 was acquired by the user is not used as a basis for determining which content items to award to the user. In such implementations, two different users acquiring the same access code 114, may receive different content from the content delivery system 120. For example, the content delivery system 120 can select the content item to be awarded to the user based solely on the user preference information 134. In such an implementation, sponsorship by a content partner 150 of a particular access code 114 is not utilized as a basis for selection of the content item to be awarded to the user. As an example, one of the content partners 150 can be selected based on the user preference information 134, and the content item that is awarded to the user can be selected from a set of content items that are associated with that content partner 150.

In some implementations, the content items that are awarded to the user are selected by the content delivery system 120 based solely on the access code 114. In one example, dissemination of one of the access codes 114 is sponsored by one or more of the content partners 150, and the content items that are selected by the content delivery system 120 in response to receiving that access code 114 from the user device are associated with the respective one or more sponsoring content partners 150. In such implementations, two different users acquiring the same access code 114 may receive similar but different content with one or more items of content being from the one or more sponsoring content partners 150.

In other implementations the content item that is awarded to the user is selected by the content delivery system 120 based on the access code 114 and user preference information 134 that is associated with the user account 130. As an example, the access code 114 can provide a user a specific one of the collectable items 124 or a specific one of the reward items 126. As another example, an access code 114 can provide a user a specific one of the collectable items 124 and a specific one of the reward items 126. As another example, an access code 114 can provide a user a specific one of the collectable items 124 or a specific one of the reward items 126 along with another content item based on user preference information 134. As another example, access code 114 can correspond to a specific set of the collectable items 124 or a specific set of the reward items 126, and a content item is selected from the specific set randomly, based on the user preference information 134 that is associated with the user account 130, or based on any other suitable criteria.

In implementations where the content item is selected at least in part based on the access code 114, the access code 114 can correspond to a predetermined one or more of the content partners 150 and provide the user one or more content items associated with that one or more content partners 150. In another implementation, the content item is selected by the server solely on the basis of the user preference information 134, without regard to the access code 114.

In cases where a content item belongs to a set of content items, the user can collect multiple content items belonging to the set. When the user content library 132 includes all of the items from a specific set of content items, an additional reward can be issued to the user by the content delivery system 120 and placed into the user content library 132, thereby incentivizing usage of the content delivery system 120 by the users.

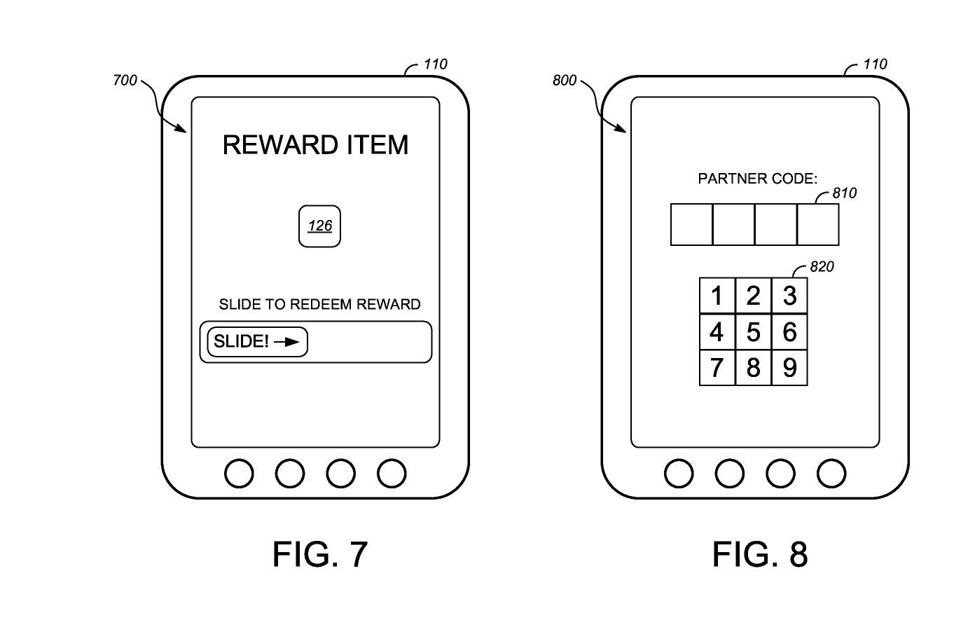

FIG. 7 is an illustration showing an example of a reward redemption interface 700 that can be defined at the user device 110. The reward redemption interface 700 can show a selected reward item 126 retrieved from the user's content library 132, and can incorporate one or more user operable interface elements that can, when operated, start a reward redemption process. The reward redemption process can be utilized at an on-line or in-store point of sale that is operated by one of the retail partners 160.

In one implementation, the reward redemption process can cause a partner interface 800 to be displayed by the user device 110, as shown in FIG. 8. The user can receive a redemption code uniquely identifying the retail partner 160 (e.g., a static or dynamic partner code 810 or an access code 114 specific to the retail partner 160 for purposes of redeeming a reward) from the retail partner 160 and enters the redemption code into the user device 110 to redeem a reward item 126. In one example, the user device 110 is a touch screen mobile telephone and the partner code 810 is entered using a keypad 820 that is displayed by the user device 110. In another example, the user can scan an access code 114, in the form of the symbolic tag 410 or the wireless tag 430, which in this case uniquely identifies the retail partner 160 and serves the purpose of redeeming the reward in lieu of entering a partner code 810. Transmission of a valid redemption code to the content delivery system 120 credits the retail partner 160 for redeeming the reward item 126 and can cause the reward item 126 to be removed from the user content library 132.

As an illustration of the reward redemption process, a user could receive a free beverage as the reward item 126. While at a restaurant, the user uses the reward redemption interface 700 to start the reward redemption process. The user device 110 displays the partner interface 800, and the user receives the partner code 810 from the retail partner 160, which in this example is the restaurant, and enters the partner code 810 into the user device 110. Once the redemption code is verified by the content delivery system 120, the retail partner 160 gives the user a free beverage. The retail partner 160 would be reimbursed for the free beverage by the operator of the content delivery system 120 or the content partner 150 that issued the reward item 126 in response to submission of the verified redemption code. In the event that the retail partner 160 was the content partner 150 that issued the reward item 126, reimbursement may not be necessary.

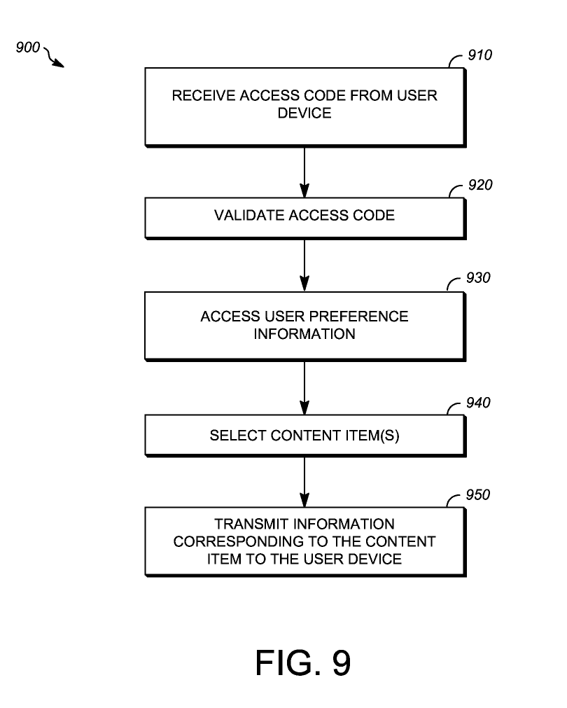

FIG. 9 is a flowchart showing an example of a process 900 for delivering content items. The operations described in connection with the process 900 can be performed at the user device 110. The process 900 can be embodied in the form of computer executable program instructions that are stored on a storage medium or storage device, which can, in some examples, be a non-transitory computer-readable storage medium or storage device. When executed by a processor, the instructions cause the processor to perform the operations that will be described herein with reference to the process 900.

At operation 910, an access code (e.g., access code 114) is received. For example, the access code 114 can be received at the content delivery system 120 from the user device 110.

At operation 920, the access code 114 is validated based on one or more validation criteria. As discussed previously, the validation criteria can include, for example, whether the user has previously submitted the same access code to the content delivery system 120, whether the user has previously submitted the same access code to the content delivery system 120 within a predetermined time period, or whether a different user has previously submitted the same access code to the content delivery system 120.

At operation 930, in response to receiving a valid access code 114, user preference information is accessed. For example, the content delivery system 120 can access user preference information 134 that is stored as part of the user account 130, which is associated with the user of the user device 110. In some implementations, this operation can be omitted.

In operation 940, content items are selected. For example one or both of collectable items 124 and reward items 126 can be selected by the content delivery system. In one implementation, the content items are selected without regard to the access code 114, but can be selected based at least in part on the user preference information 134. In another implementation, the content items are selected based at least in part on the access code 114, such as by selecting one or more content items from a set of content items that are associated with one or more of the content partners 150 that are associated with the access code 114. In some implementations, the content items are selected based at least in part on the user preference information.

In operation 950, information corresponding to the one or more content items that were selected in operation 940 is transmitted to the user device 110 by the content delivery system 120. For example, the content delivery system 120 can transmit one or both of the collectable item award message 610 and the reward item award message 620 to the user device 110. The user content library 132 can also be updated to reflect the user's access to the newly awarded content items.

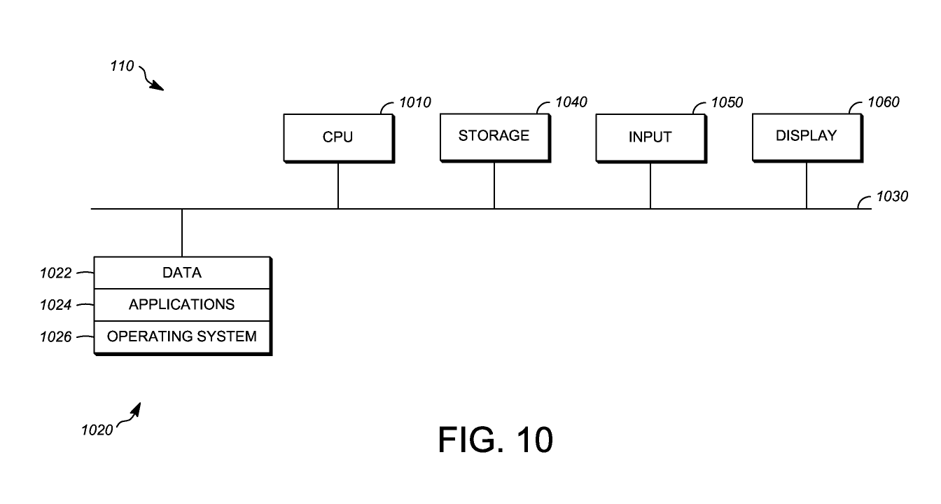

FIG. 10 is a block diagram of an example of a hardware configuration for the user device 110. Other computers and/or devices described herein can be implemented using a similar configuration.

The CPU 1010 of the user device 110 can be a conventional central processing unit. Alternatively, the CPU 1010 can be any other type of device, or multiple devices, capable of manipulating or processing information now-existing or hereafter developed. Although the disclosed examples can be practiced with a single processor as shown, e.g. CPU 1010, advantages in speed and efficiency can be achieved using more than one processor.

The user device 110 can include memory 1020, such as a random access memory device (RAM). Any other suitable type of storage device can be used as the memory 1020. The memory 1020 can include code and data 1022, one or more application programs 1024, and an operating system 1026, all of which can be accessed by the CPU 1010 using a bus 1030. The application programs 1024 can include programs that permit the CPU 1010 to perform the methods described here.

A storage device 1040 can be optionally provided in the form of any suitable computer readable medium, such as a hard disc drive, a memory device, a flash drive or an optical drive. One or more input devices 1050, such as a keyboard, a mouse, or a gesture sensitive input device, receive user inputs and can output signals or data indicative of the user inputs to the CPU 1010. One or more output devices can be provided, such as a display device 1060. The display device 1060, such as a liquid crystal display (LCD) or a cathode-ray tube (CRT), allows output to be presented to a user, for example, in response to receiving a video signal.

Although the CPU 1010 and the memory 1020 of the user device 110 are depicted as being integrated into a single unit, other configurations can be utilized. The operations of the CPU 1010 can be distributed across multiple machines (each machine having one or more of processors) which can be coupled directly or across a local area or other network. The memory 1020 can be distributed across multiple machines such as network-based memory or memory in multiple machines performing the operations of the user device 110. Although depicted here as a single bus, the bus 1030 of the user device 110 can be composed of multiple buses. Further, the storage device 1040 can be directly coupled to the other components of the user device 110 or can be accessed via a network and can comprise a single integrated unit such as a memory card or multiple units such as multiple memory cards. The user device 110 can thus be implemented in a wide variety of configurations.

The computers and/or devices described herein (and the algorithms, methods, instructions etc. stored thereon and/or executed thereby) can be realized in hardware including, for example, intellectual property (IP) cores, application-specific integrated circuits (ASICs), programmable logic arrays, optical processors, programmable logic controllers, microcode, firmware, microcontrollers, servers, microprocessors, digital signal processors or any other suitable circuit. In the claims, the term “processor” should be understood as encompassing any the foregoing, either singly or in combination. The terms “signal” and “data” are used interchangeably.

In some implementations, operations described herein as being performed by a single computer or device can be performed by multiple computers and/or devices. In other implementations, the operations described herein as being performed by multiple computers and/or devices can be performed by a single computer or device. Although illustrated for simplicity as unitary machines, it is understood that the computers and devices shown and described herein are not necessarily implemented using a single processor, or a single physical machine. Moreover, although features may be described above or claimed as acting in certain combinations, one or more features of a combination can in some cases be excised from the combination, and the combination may be directed to a sub-combination or variation of a sub-combination.

In another example, the computers and or devices described herein can be implemented using general purpose computers/processors with a computer program that, when executed, carries out any of the respective methods, algorithms and/or instructions described herein. In addition or alternatively, for example, special purpose computers/processors can be utilized which can contain specialized hardware for carrying out any of the methods, algorithms, or instructions described herein.

Further, all or a portion of the embodiments of the disclosure can take the form of a computer program product accessible from, for example, a storage device or storage medium such as a non-transitory computer-usable or computer-readable medium. A storage device or storage medium can be any device that can, for example, tangibly contain, store, communicate, or transport the program for use by or in connection with any processor. The storage device or storage medium can be, for example, an electronic device, magnetic device, optical device, electromagnetic device, or a semiconductor device. Other suitable devices and mediums are also available.

While this disclosure includes what is presently considered to be the most practical and preferred embodiments, it is to be understood that the disclosure is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A method, comprising:
receiving an access code at one or more server computers from a user device that is associated with a user; and
in response to receiving the access code at the one or more server computers:
accessing, at the one or more server computers, user preference information that is associated with the user of the user device,
selecting a set of content items based at least in part on the access code,
selecting at least one content item from the set of content items based at least in part on the user preference information, and
transmitting information corresponding to the at least one content item from the one or more server computers to the user device.

2. The method of claim 1, wherein the access code and the set of content items both correspond to a predetermined content partner.

3. The method of claim 1, wherein selecting the at least one content item based at least in part on the user preference information includes comparing the user preference information to at least one of the following:
item characteristic information that is associated with each content item from the set of content items; or
partner characteristic information that is associated with a predetermined content partner.

4. The method of claim 1, further comprising:
in response to receiving the access code at the one or more server computers, validating the access code, and authorizing transmission of the at least one content item to the user device if the access code is valid.

5. The method of claim 4, wherein validating the access code includes determining whether at least one validation criterion is satisfied.

6. The method of claim 5, wherein the at least one validation criterion includes a time value and wherein the time value is at least one of associated with receipt of the access code at the user device or associated with receipt of the access code at the one or more server computers.

7. The method of claim 5, wherein the at least one validation criterion includes geolocation information associated with receipt of the access code at the user device.

8. The method of claim 1, wherein the at least one content item is a reward item, further comprising:
receiving a redemption code at the one or more server computers from the user device, wherein the redemption code permits the user to redeem the reward item.

9. The method of claim 1, wherein the access code is received at the user device from a symbolic tag that is scanned by the user device.

10. The method of claim 1, wherein the access code is included in at least one of a print media, magazine, a printed advertisement, a newspaper, a signs, a poster, a flyer, a billboard, mail, confetti, a window decal, a menus, a napkin, a table tent, a business cards, a bumper sticker, a banner, a wall hanging, a projected image, an e-mail, live television broadcast, recorded television broadcast, digital video recording content, an internet transmission, a webpage, a banner advertisement, a digital photo, a digital image, a social media feed, a pop up advertisement, a mobile device, a tablet, a computer or a video monitor.

11. The method of claim 1, wherein the access code is received at the user device via wireless transmission.

12. The method of claim 1, wherein selecting the at least one content item from the set of content items based at least in part on the user preference information includes selecting a collectable item based on the user preference information and selecting a reward item based on the user preference information.

13. The method of claim 1, wherein selecting the at least one content item from the set of content items based at least in part on the user preference information includes selecting a collectable item based on the user preference information and selecting a reward item based on the access code.

14. The method of claim 1, further comprising:
receiving a request at the one or more server computers to at least one of:
trade access to the at least one content item for access to another content item; or
gift access to the at least one content item to another user.

15. The method of claim 1, wherein the user preference information includes user rankings of a plurality of content items, wherein selecting the at least one content item based at least in part on the user preference information further comprises:
selecting the at least one content item from the set of content items based on the user rankings of the plurality of content items.

16. A method, comprising:
receiving an access code at one or more server computers from a user device that is associated with a user; and
in response to receiving the access code at the one or more server computers:
accessing, at the one or more server computers, user preference information that is associated with the user of the user device,
selecting at least one content item based at least in part on the user preference information and not based on the access code, and
transmitting information corresponding to the at least one content item from the one or more server computers to the user device.

17. The method of claim 16, wherein selecting the at least one content item based at least in part on the user preference information includes comparing the user preference information to at least one of the following:
item characteristic information that is associated with each of at least some of a plurality of content items; or
partner characteristic information that is associated with each of at least some of a plurality content partners.

18. The method of claim 16, further comprising:
in response to receiving the access code at the one or more server computers, validating the access code, and authorizing transmission of the at least one content item to the user device if the access code is valid, wherein validating the access code includes determining whether at least one validation criterion is satisfied.

19. The method of claim 18, wherein the at least one validation criterion includes a time value and wherein the time value is at least one of associated with receipt of the access code at the user device or associated with receipt of the access code at the one or more server computers.

20. The method of claim 18, wherein the at least one validation criterion includes geolocation information associated with receipt of the access code at the user device.

21. The method of claim 16, wherein the at least one content item is a reward item, further comprising:
receiving a redemption code at the one or more server computers from the user device, wherein the redemption code permits the user to redeem the reward item.

22. The method of claim 16, wherein the access code is received at the user device from a symbolic tag that is scanned by the user device.

23. The method of claim 16, wherein the access code is included in at least one of a print media, magazine, a printed advertisement, a newspaper, a signs, a poster, a flyer, a billboard, mail, confetti, a window decal, a menus, a napkin, a table tent, a business cards, a bumper sticker, a banner, a wall hanging, a projected image, an e-mail, live television broadcast, recorded television broadcast, digital video recording content, an internet transmission, a webpage, a banner advertisement, a digital photo, a digital image, a social media feed, a pop up advertisement, a mobile device, a tablet, a computer or a video monitor.

24. The method of claim 16, wherein the access code is received at the user device via wireless transmission.

25. The method of claim 16, wherein selecting the at least one content item from the set of content items based at least in part on the user preference information includes selecting a collectable item based on the user preference information and selecting a reward item based on the user preference information.

26. The method of claim 16, further comprising:
receiving a request at the one or more server computers to at least one of:
trade access to the at least one content item for access to another content item; or
gift access to the at least one content item to another user.

27. The method of claim 16, wherein the user preference information includes user rankings of a plurality of content items, wherein selecting the at least one content item based at least in part on the user preference information further comprises:
selecting the at least one content item from the set of content items based on the user rankings of the plurality of content items.

28. A method, comprising:
causing an access code to be transmitted along with video content, wherein the access code is received at a user device that is associated with a user;
receiving the access code and a time value from the user device at one or more server computers, wherein the time value corresponds to a time at which the access code was received at the user device; and
in response to receiving the access code at the one or more server computers:
validating the access code based at least in part on the time value, wherein the access code is valid if the time value occurs within a predetermined time period after transmission of the video content,
selecting at least one content item, and
transmitting information corresponding to the at least one content item from the one or more server computers to the user device.
